(19) United States
(12) Patent Application Publication
(10) Pub. No.: US 2025/0369558 A1
(43) Pub. Date: Dec. 4, 2025

(54) INSTALLATION METHOD AND JIG SET

(71) Applicant: Konica Minolta, Inc., Tokyo (JP)

(72) Inventors: Hironao Miyamoto, Tokyo (JP); Takumi Sakurada, Tokyo (JP); Yoshiyuki Toso, Tokyo (JP); Yusuke Murakami, Tokyo (JP)

(73) Assignee: Konica Minolta, Inc., Tokyo (JP)

(21) Appl. No.: 19/202,933

(22) Filed: May 8, 2025

(30) Foreign Application Priority Data
Jun. 4, 2024 (JP) 2024-090744

(51) Int. Cl. F16M 13/02; F16B 1/00

(52) U.S. Cl. CPC F16M 13/02; F16B 1/00

(57) ABSTRACT

An installation method for installing an optical measuring instrument on an installation mount by using a positioning plate, includes: joining a first joint provided on the positioning plate to a second joint provided on the installation mount; and joining a third joint provided on the positioning plate to an opening provided in the optical measuring instrument, the opening defining an optical path of the optical measuring instrument.

### CROSS-REFERENCE TO RELATED APPLICATIONS

The entire disclosure of Japanese Patent Application No. 2024-090744, filed on Jun. 4, 2024, is incorporated herein by reference in its entirety.

### BACKGROUND OF THE INVENTION

### Technical Field

The present disclosure relates to an installation method and a jig set for installing an optical measuring instrument on an installation mount.

### Description of Related Art

A system for automatically measuring optical characteristics of a plurality of samples successively (hereinafter referred to as “automatic measurement system”) has been conventionally developed. For example, the automatic measurement system includes an optical measuring instrument, a robot that sequentially picks up the samples, and a controller that controls the robot to move the samples to a target measurement position of the optical measuring instrument. In order to accurately move the samples to the target measurement position where measurement is to be done by the optical measuring instrument, the optical measuring instrument, the sample, and the robot have to be positioned in advance at respective target positions in a workspace. For this purpose, various positioning techniques have been developed.

For example, Japanese Laid-Open Patent Publication No. S61-294507 discloses a technique for positioning a robot hand at a certain position in a workspace. Japanese Laid-Open Patent Publication No. 2015-208791 discloses a technique for correcting a positional deviation of a measuring instrument with respect to a sample.

In general, a stationary optical measuring instrument may have a structure (such as holes and elongated holes, for example) for being positioned at a specific position in a workspace. However, a user may desire to incorporate, into an automatic measurement system, an optical measuring instrument (e.g., a handy type optical measuring instrument) that the user has used. The handy type optical measuring instrument is not designed to be positionable at a specific position in a workspace. Therefore, for the user to incorporate such an optical measuring instrument into an automatic measurement system, it takes time and effort to accurately position the optical measuring instrument at the specific position in the workspace.

None of the techniques disclosed in Japanese Laid-Open Patent Publication No. S61-294507 and Japanese Laid-Open Patent Publication No. 2015-208791 aims at positioning an optical measuring instrument at a specific position in a workspace.

### SUMMARY

In order to solve these problems, one object of the present disclosure is to accurately position an optical measuring instrument.

To achieve at least the abovementioned object, according to an aspect of the present invention, an installation method reflecting one aspect of the present invention is an installation method for installing an optical measuring instrument on an installation mount by using a positioning member (or positioning plate), and the installation method includes: joining a first joint provided on the positioning member to a second joint provided on the installation mount; and joining a third joint provided on the positioning member to an opening provided in the optical measuring instrument, the opening defining an optical path of the optical measuring instrument.

To achieve at least the abovementioned object, according to an aspect of the present invention, a jig set reflecting one aspect of the present invention includes: an installation mount; and a positioning member (or positioning plate) that assists installation of an optical measuring instrument on the installation mount. The positioning member includes a first joint that has a shape capable of being joined to a second joint provided on the installation mount. The positioning member further includes a third joint that has a shape capable of being joined to an opening provided in the optical measuring instrument, the opening defining an optical path of the optical measuring instrument. The installation mount includes a support mechanism that supports the optical measuring instrument to maintain a relative positional relationship between the installation mount and the optical measuring instrument, in a state where the first joint is joined to the second joint and the third joint is joined to the opening.

The above and other objects, features, aspects and advantages of the present invention will become apparent from the following detailed description of the present invention which is to be understood in conjunction with the accompanying drawings.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a diagram illustrating an example of an overall configuration of an automatic measurement system according to the present embodiment.

FIG. 2 is a diagram illustrating an example of a stationary optical measuring instrument.

FIG. 3 is an external perspective view of an example of an optical measuring instrument having no structure for positioning.

FIG. 4 is an exploded perspective view of the optical measuring instrument illustrated in FIG. 3.

FIG. 5 is an external perspective view illustrating an example of an installation mount.

FIG. 6 is a front view illustrating an upper part of the installation mount illustrated in FIG. 5.

FIG. 7 is a cross-sectional view taken along A-A in FIG. 6, as seen in the direction of the arrows.

FIG. 8 is an enlarged view of the inside of a frame indicated by a broken line in FIG. 7.

FIG. 9 is an external perspective view illustrating an example where the installation mount is incorporated into the automatic measurement system.

FIG. 10 is an external perspective view illustrating an example of a positioning member.

FIG. 11 is a side view of the positioning member illustrated in FIG. 10. FIG. 12 is a front view of the positioning member illustrated in FIG. 10.

FIG. 13 is a flowchart illustrating an example of a flow of a method for installing an optical measuring instrument 2.

FIG. 14 is a diagram illustrating step S3.

FIG. 15 is a diagram illustrating a positional relationship between an opening of the optical measuring instrument and pins of the positioning member.

FIG. 16 is a diagram illustrating step S2.

FIG. 17 is an external perspective view of an upper part of the installation mount after completion of steps S2 and S3.

### DETAILED DESCRIPTION

Hereinafter, one or more embodiments of the present invention will be described with reference to the drawings. However, the scope of the invention is not limited to the disclosed embodiments.

In the following, embodiments and modifications according to the present disclosure are described with reference to the drawings. In the following description, the same parts and constituent elements are denoted by the same reference characters. Their names and functions are also identical to each other. Therefore, a detailed description thereof is not herein repeated. Note that the embodiments and modifications described below may be selectively combined as appropriate.

### Overall Configuration of Automatic Measurement System

FIG. 1 is a diagram illustrating an example of an overall configuration of an automatic measurement system according to the present embodiment. As illustrated in FIG. 1, the automatic measurement system 100 includes an optical measuring instrument 2, a robot 3, a tray 4, a bedplate 6, and a computer 8.

The tray 4 is used for placing, on the tray, one or more samples 5 whose optical characteristics are to be measured. The tray 4 has an L-shaped guide 41 for positioning each sample 5. In the example illustrated in FIG. 1, the sample 5 has a rectangular shape as seen in a plan view. The sample 5 is placed so that one corner and two sides defining the corner of the sample 5 are in contact with a corner and two sides of the guide 41. Thus, the sample 5 is placed in a specific orientation at a specific position on the tray 4.

The robot 3 picks up the sample 5. The robot 3 is not particularly limited, but is, for example, a vertical articulated robot. The robot 3 includes a base 301, an arm 302, and an end effector 303. The arm 302 is provided on the base 301. The end effector 303 is attached to the distal end of the arm 302 and has a mechanism for holding the sample 5. The mechanism for holding the sample 5 includes, for example, a suction pad.

The tray 4 and the base 301 of the robot 3 are installed on the bedplate 6. The bedplate 6 has a structure (such as parallel pins, for example) for positioning the tray 4 and the base 301. Thus, the tray 4 and the base 301 of the robot 3 are each installed in a specific orientation at a specific position on the bedplate 6.

The optical measuring instrument 2 measures optical characteristics of the sample 5. The optical measuring instrument 2 is not particularly limited, but is, for example, a colorimeter or a glossmeter. The optical measuring instrument 2 includes a light projecting element 27 that emits light toward the sample 5, and one or more light receiving elements 28 that receive the light reflected from the sample 5. Therefore, an opening 21 for defining an optical path is formed in the optical measuring instrument 2. That is, the light emitted from the light projecting element 27 is passed through the opening 21 and cast outward. The light receiving element 28 receives, through the opening 21, reflected light from the outside. The opening 21 is also referred to as an aperture. The position and the shape of the opening 21 influence the performance of the optical measuring instrument 2. Therefore, the optical measuring instrument 2 is manufactured in such a manner that makes errors in the position and the shape of the opening 21 as small as possible.

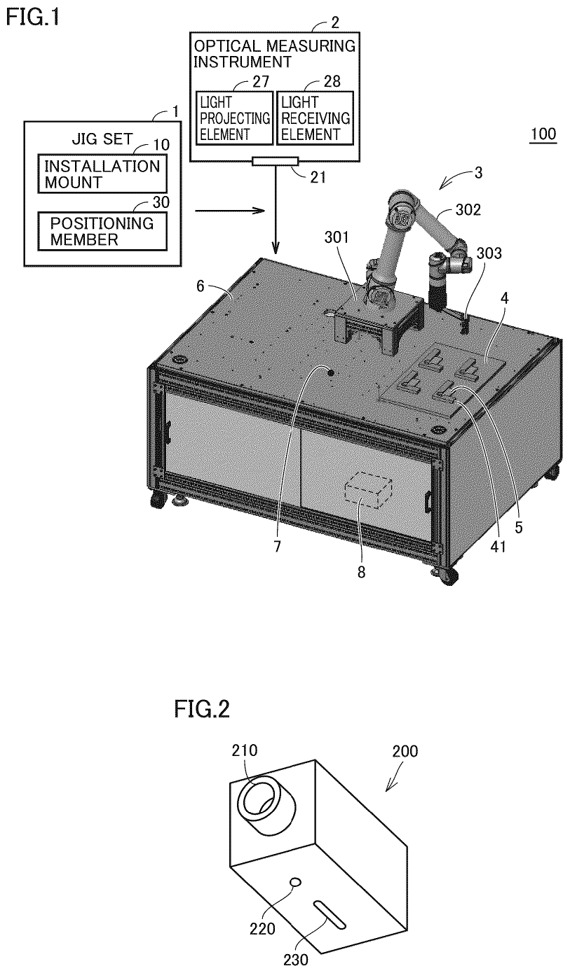

FIG. 2 is a diagram illustrating an example of a stationary optical measuring instrument. The optical measuring instrument 200 illustrated in FIG. 2 has a substantially cubic shape. An opening 21 is formed in a side surface of the optical measuring instrument 200. A hole 220 and an elongated hole 230 are formed in the bottom surface of the optical measuring instrument 200.

The bedplate 6 may have two pins that can be inserted into the hole 220 and the elongated hole 230, to serve as a structure for positioning the optical measuring instrument 200. Thus, the optical measuring instrument 200 is easily positioned on the bedplate 6.

However, as described above, a user may desire to incorporate, into the automatic measurement system 100, a device (for example, a handy type device) that does not have a structure (for example, the hole 220 and the elongated hole 230) for positioning at a specific position in a workspace, to serve as the optical measuring instrument 2. Therefore, as illustrated in FIG. 1, the automatic measurement system 100 according to the present embodiment includes a jig set 1 that supports positioning of the opening 21 of the optical measuring instrument 2. The jig set 1 includes an installation mount 10 and a positioning member 30. Details of a method for installing the optical measuring instrument 2 by using the jig set 1 is described later herein.

A system origin 7 is an origin of a workspace where the automatic measurement system 100 is provided. In the example illustrated in FIG. 1, the system origin 7 is set on the bedplate 6. As described above, the tray 4 and the base 301 of the robot 3 are each installed in the

specific orientation at the specific position on the bedplate 6. Further, the sample 5 is placed in the specific orientation at the specific position on the tray 4. Therefore, the position and orientation of the robot 3 are specified by coordinates and Euler angles of a Cartesian coordinate system (orthogonal coordinate system) having the system origin 7. Similarly, the position and orientation of each sample 5 are specified by coordinates and Euler angles of the Cartesian coordinate system having the system origin 7.

Further, the position and orientation of the opening 21 of the optical measuring instrument 2 are determined by using the jig set 1. Therefore, the position and orientation of the opening 21 of the optical measuring instrument 2 are also specified by coordinates and Euler angles of the Cartesian coordinate system having the system origin 7.

The computer 8 controls the robot 3 in such a manner that causes the samples 5 to be picked up successively and moved to a target measurement position that faces the opening 21 of the optical measuring instrument 2. The computer 8 stores respective positions and orientations of the base 301 of the robot 3, the sample 5, and the opening 21 of the optical measuring instrument 2. The computer 8 controls an operation of the robot 3 based on these positions and orientations.

Specifically, the computer 8 acquires a displacement amount of each axis of the robot 3, from an encoder of the robot 3. The computer 8 calculates the current position and orientation of the end effector 303, based on the position and orientation of the base 301 and the displacement amount. The computer 8 calculates a first target position-and-orientation to be taken by the end effector 303 for holding the sample 5, based on the position and orientation of the sample 5. The first target position-and-orientation is the position and orientation of the end effector 303 when holding a predetermined holding point of the sample 5. The computer 8 calculates a first target path of the end effector 303 for moving the end effector 303 to the first target position-and-orientation, based on the current position and orientation of the end effector 303 and the first target position-and-orientation. The computer 8 controls the robot 3 in such a manner that causes the end effector 303 to operate along the first target path.

The computer 8 calculates the target measurement position that faces the opening 21, based on the position and orientation of the opening 21 of the optical measuring instrument 2.

In response to the end effector 303 holding the sample 5, the computer 8 calculates a second target position-and-orientation of the end effector 303 to be taken when a predetermined target point of the sample 5 coincides with the target measurement position. The computer 8 may calculate the second target position-and-orientation, based on the current position and orientation of the end effector 303 and the relative positional relationship between the holding point and the target point. The computer 8 calculates a second target path of the end effector 303 for moving the end effector 303 to the second target position-and-orientation, based on the current position and orientation of the end effector 303 and the second target position-and-orientation. The computer 8 controls the robot 3 in such a manner that causes the end effector 303 to operate along the second target path.

In response to the end effector 303 reaching the second target position-and-orientation, the computer 8 outputs a trigger signal for starting measurement, to the optical measuring instrument 2. Thus, optical characteristics of the target point of the sample 5 are automatically measured by the optical measuring instrument 2. After the measurement is completed, the computer 8 controls the robot 3 in such a manner that causes the sample 5 to return to the tray 4.

### Example of Optical Measuring Instrument

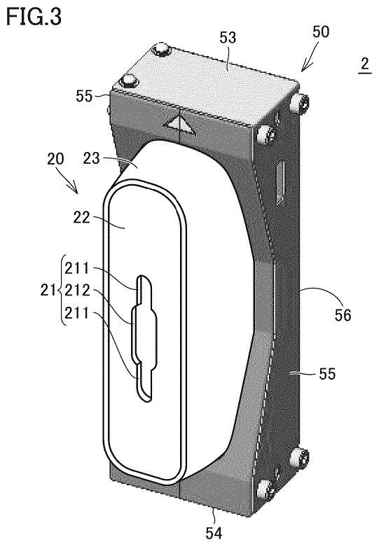

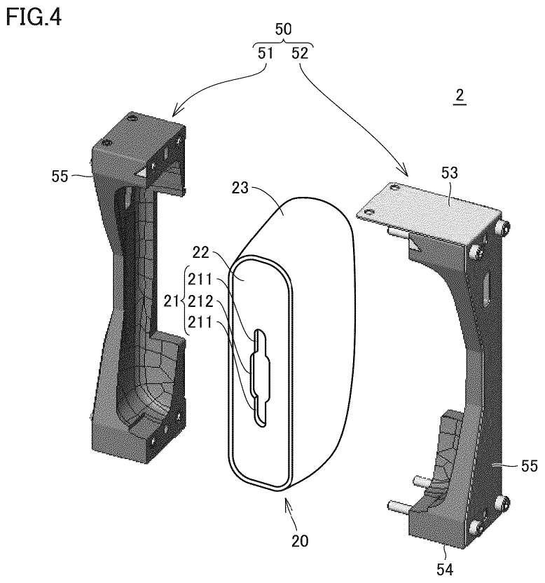

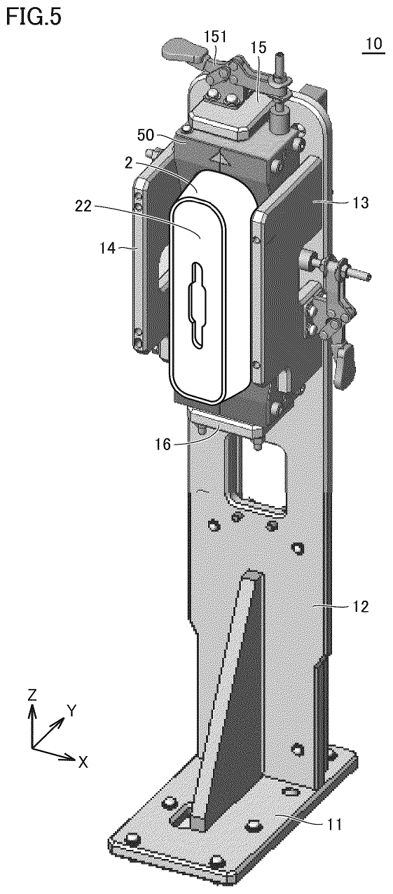

FIG. 3 is an external perspective view of an example of the optical measuring instrument having no structure for positioning. FIG. 4 is an exploded perspective view of the optical measuring instrument illustrated in FIG. 3. FIG. 3 illustrates an optical measuring instrument 2 of handy type. The optical measuring instrument 2 includes a measuring instrument body 20 and a holder 50.

The measuring instrument body 20 contains the light projecting element 27 and one or more light receiving elements 28 illustrated in FIG. 1. The measuring instrument body 20 may contain a plurality of light receiving elements 28.

The opening 21 for defining the optical path is formed in a housing of the measuring instrument body 20. For the measuring instrument body 20 containing a plurality of light receiving elements 28, the opening 21 is required to define an optical path for each of the plurality of light receiving elements 28. In other words, the opening 21 is required to define optical paths having a plurality of projection angles. Therefore, as illustrated in the drawing, the opening 21 has a shape of a substantially elongated hole. The opening 21 includes two first portions 211 having a relatively smaller width in a lateral direction (short-length direction) of the shape of the substantially elongated hole, and a second portion 212 having a relatively larger width in the lateral direction of the shape of the substantially elongated hole. The second portion 212 is located between the two first portions 211.

The outer surface of the measuring instrument body 20 includes a flat surface 22 in which the opening 21 is formed. In other words, the flat surface 22 is a surface around the opening 21. The flat surface 22 is in close contact with a measurement object (e.g., a sample 5) whose optical characteristics are to be measured. Thus, ambient light is prevented from entering the opening 21.

The outer surface of the measuring instrument body 20 further includes a curved surface (hereinafter referred to as “outer curved surface 23”) designed to be held easily in a human hand.

The holder 50 is attached to the measuring instrument body 20 so as to cover the outer curved surface 23. As illustrated in FIG. 4, the holder 50 includes a part 51 and a part 52. The part 51 and the part 52 sandwich the measuring instrument body 20, and are connected to each other with screws. Thus, the holder 50 is integrated with the measuring instrument body 20.

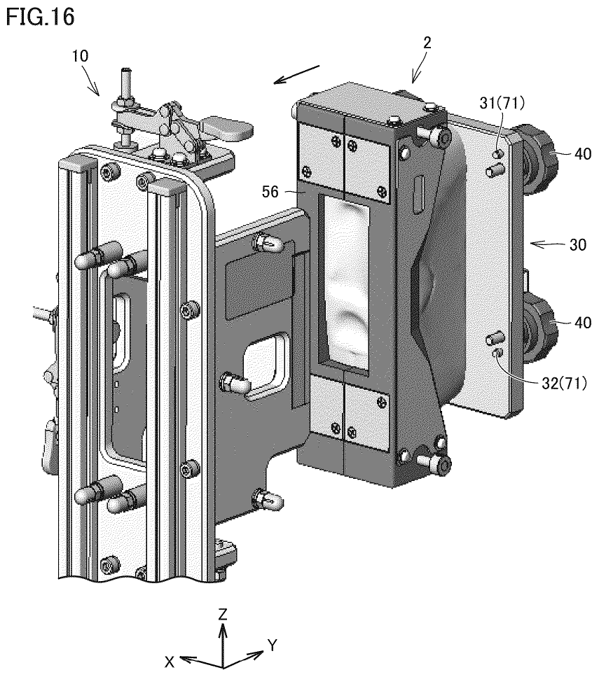

The outer surface of the holder 50 includes a back surface 56 (illustrated in FIG. 16) that is parallel to the flat surface 22 of the measuring instrument body 20, in a state where the holder 50 is integrated with the measuring instrument body 20. Further, the outer surface of the holder 50 includes an upper surface 53 and a lower surface 54 that are orthogonal to a longitudinal direction of the opening 21 of the measuring instrument body 20, in a state where the holder 50 is integrated with the measuring instrument body 20. In addition, the outer surface of the holder 50 includes two side surfaces 55 that are parallel to the longitudinal direction of the opening 21 of the measuring instrument body 20 and orthogonal to the flat surface 22 and the back surface 56, in a state where the holder 50 is integrated with the measuring instrument body 20.

Each of the upper surface 53, the lower surface 54, the two side surfaces 55, and the back surface 56 is flat, and is an example of “outer flat surface” of the present disclosure.

For using the optical measuring instrument 2 as a portable instrument, a user detaches the holder 50 from the measuring instrument body 20 and holds the measuring instrument body 20 to measure optical characteristics of the measurement object. When a user desires to incorporate the optical measuring instrument 2 into the automatic measurement system 100, the user attaches the holder 50 to the measuring instrument body 20.

### Example of Installation Mount

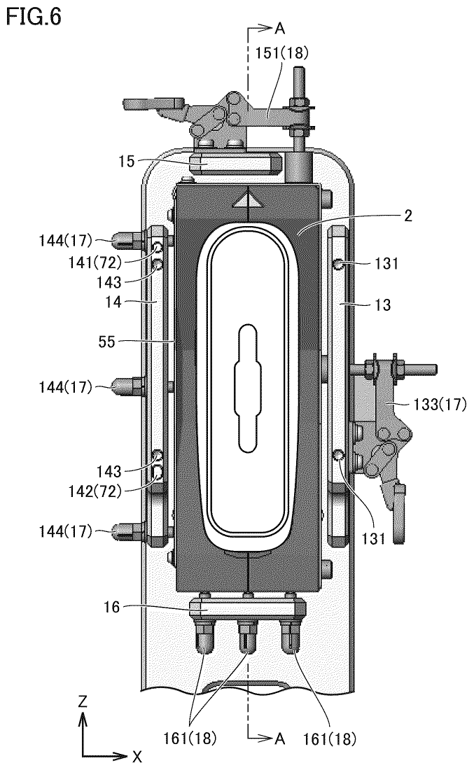

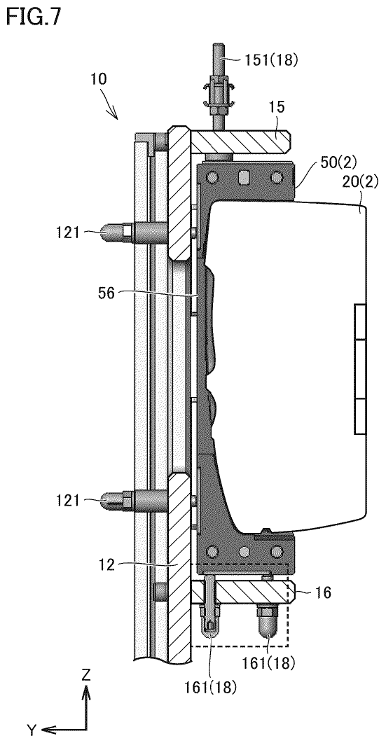

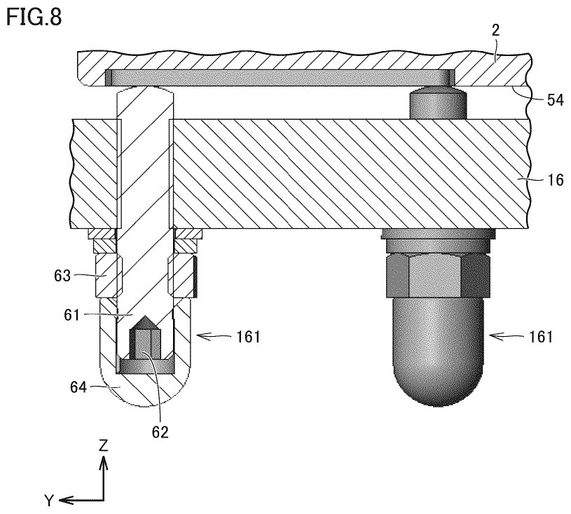

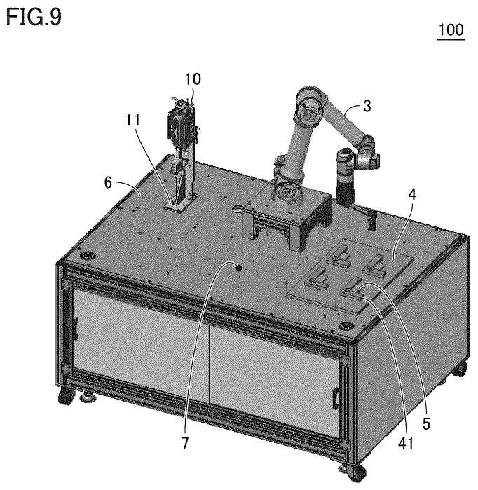

An example of the installation mount 10 is described with reference to FIGS. 5 to 9. FIG. 5 is an external perspective view illustrating an example of the installation mount. FIG. 6 is a front view illustrating an upper part of the installation mount illustrated in FIG. 5. FIG. 7 is a cross-sectional view taken along A-A in FIG. 6, as seen in the direction of the arrows. FIG. 8 is an enlarged view of the inside of a frame indicated by a broken line in FIG. 7. Note that FIGS. 5 to 7 illustrate the installation mount 10 when supporting the optical measuring instrument 2. FIG. 9 is an external perspective view illustrating an example where the installation mount is incorporated into the automatic measurement system.

As illustrated in FIG. 5, the installation mount 10 includes a base plate 11 and an upright plate 12 that is perpendicularly erected on the base plate 11. FIGS. 5 to 7 illustrate a coordinate system having X, Y, and Z axes as the Cartesian coordinate system with respect to the installation mount 10. The Z axis is parallel to the direction orthogonal to the base plate 11. The Y axis is parallel to the direction orthogonal to the upright plate 12. The X axis is orthogonal to the Y axis and the Z axis, and is parallel to the base plate 11 and the upright plate 12. The X-axis direction is an example of “second direction” of the present disclosure. The Y-axis direction is an example of “first direction” of the present disclosure. The Z-axis direction is an example of “third direction” of the present disclosure.

The installation mount 10 further includes a right side plate 13, a left side plate 14, an upper plate 15, and a lower plate 16 that are perpendicularly erected on one surface of the upright plate 12 (in the drawings, the surface on the-Y side). The right side plate 13 and the left side plate 14 are orthogonal to the X axis and are arranged so as to face each other. The upper plate 15 and the lower plate 16 are arranged so as to be orthogonal to the Z axis and face each other. The upper plate 15 and the lower plate 16 are arranged so as to sandwich a space between the right side plate 13 and the left side plate 14. As illustrated in FIGS. 5 to 7, a space surrounded by the right side plate 13, the left side plate 14, the upper plate 15, and the lower plate 16 is sized to be capable of accommodating the optical measuring instrument 2. The optical measuring instrument 2 is installed on the installation mount 10 by an installation method described later herein, in such a manner that makes the flat surface 22 orthogonal to the Y axis.

The height of the left side plate 14 (i.e., the length in the Y direction) with respect to the upright plate 12 is identical to the height of the right side plate 13 (i.e., the length in the Y direction) with respect to the upright plate 12.

A hole 141 and an elongated hole 142 are formed in an end face of the left side plate 14 opposite to the upright plate 12. A longitudinal direction of the elongated hole 142 is parallel to the Z-axis direction. A line connecting the center of the hole 141 and the center of the elongated hole 142 is parallel to the Z-axis direction. The hole 141 and the elongated hole 142 form a second joint 72. Further, one or more screw holes 143 are formed in the end face of the left side plate 14 opposite to the upright plate 12. In the example illustrated in FIG. 6, two screw holes 143 are formed in the left side plate 14.

One or more screw holes 131 are formed in an end face of the right side plate 13, opposite to the upright plate 12. In the example illustrated in FIG. 6, two screw holes 131 are formed in the right side plate 13.

The installation mount 10 is further provided with a support mechanism for supporting the optical measuring instrument 2. The support mechanism includes three or more adjusters 121 whose positions are adjustable along the Y-axis direction. The three or more adjusters 121 are provided on the upright plate 12. The three or more adjusters 121 are an example of “first support member” or “first support tool” of the present disclosure. In the example illustrated in FIGS. 5 to 7, the support mechanism includes four adjusters 121.

Further, the support mechanism includes a set of support members 17 of which position is adjustable along the X-axis direction, and which is capable of holding an object in between. The set of support members 17 is an example of “second support member” or “second support tool” of the present disclosure. The set of support members 17 includes three or more adjusters 144 whose positions with respect to the optical measuring instrument 2 are adjustable, and a toggle clamp 133 that is located opposite to the three or more adjusters 144 across the optical measuring instrument 2, and presses the optical measuring instrument 2 toward the three or more adjusters 144. The three or more adjusters 144 are provided on the left side plate 14 and are movable along the X-axis direction. In the example illustrated in FIGS. 5 to 7, the set of support members 17 includes three adjusters 144. The toggle clamp 133 is attached to the right side plate 13. The toggle clamp 133 is an example of “presser” of the present disclosure.

Further, the support mechanism includes a set of support members 18 of which position is adjustable along the Z-axis direction, and which are capable of holding an object in between. The set of support members 18 is an example of “third support member” or “third support tool” of the present disclosure. The set of support members 18 includes three or more adjusters 161 whose positions with respect to the optical measuring instrument 2 are adjustable, and a toggle clamp 151 that is located opposite to the three or more adjusters 161 across the optical measuring instrument 2, and presses the optical measuring instrument 2 toward the three or more adjusters 161. The three or more adjusters 161 are provided on the lower plate 16 and are movable along the Z-axis direction. In the example illustrated in FIGS. 5 to 7, the set of support members 18 includes three adjusters 161. The toggle clamp 151 is attached to the upper plate 15. The toggle clamp 151 is an example of “presser” of the present disclosure.

As illustrated in FIG. 8, the adjuster 161 includes a bolt 61, a nut 63, and a cap 64. A hexagonal hole 62 is formed in a head portion of the bolt 61. The bolt 61 is screwed into a through screw hole of the lower plate 16. The bolt 61 rotates to move along the Z direction. The nut 63 is screwed on the bolt 61 until the nut 63 contacts the lower plate 16, to thereby fix the position of the bolt 61. The cap 64 covers the head portion of the bolt 61. The cap 64 is removed for adjusting the position of the bolt 61. After the position of the bolt 61 is adjusted, the cap 64 is attached to the head portion of the bolt 61. Thus, an unintended change in the position of the bolt 61 is avoided.

The adjuster 121 has the same structure as the adjuster 161. It should be noted that the bolt 61 of the adjuster 121 is screwed into a through screw hole of the upright plate 12, and rotates to move along the Y direction.

The adjuster 144 also has the same structure as the adjuster 161. It should be noted that the bolt 61 of the adjuster 144 is screwed into a through screw hole of the left side plate 14, and rotates to move along the X direction.

As illustrated in FIG. 9, the base plate 11 of the installation mount 10 is mounted on the bedplate 6 of the automatic measurement system 100. The bedplate 6 has a structure (for example, parallel pins or the like) for positioning the base plate 11. The base plate 11 is mounted on the bedplate 6 so as to be joined to the structure. Thus, the base plate 11 is attached in a specific orientation at a specific position on the bedplate 6. Therefore, the position and the orientation of the installation mount 10 are specified by coordinates and Euler angles of the Cartesian coordinate system having the system origin 7.

### Example of Positioning Member

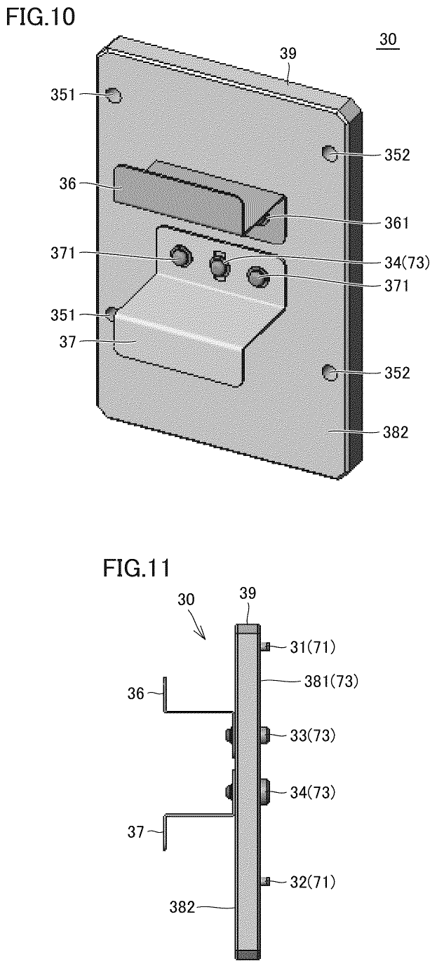

An example of the positioning member 30 is described with reference to FIGS. 10 to 12. FIG. 10 is an external perspective view illustrating an example of the positioning member. FIG. 11 is a side view of the positioning member illustrated in FIG. 10. FIG. 12 is a front view of the positioning member illustrated in FIG. 10.

The positioning member 30 illustrated in FIGS. 10 to 12 includes a rectangular plate 39, pins 31 to 34, and handles 36 and 37.

The pins 31 and 32 are attached to the plate 39 so as to protrude from one flat main surface 381 of the plate 39. The pins 31 and 32 each form a first joint 71 and have a shape that can be joined to a second joint 72 provided on the installation mount 10. Specifically, the diameter of the pin 31 is designed to be slightly smaller than the diameter of the hole 141 of the installation mount 10. The diameter of the pin 32 is designed to be slightly smaller than the width, in the lateral direction, of the elongated hole 142 of the installation mount 10. The distance between the central axis of the pin 31 and the central axis of the pin 32 is designed to be equal to the distance between the center of the hole 141 and the center of the elongated hole 142. The pins 31 and 32 are arranged near one side surface 391 of the rectangular plate 39, along the side surface 391.

The pins 33 and 34 penetrate through respective through holes 393 and 394 provided in the plate 39. One end of the pin 33 protrudes from the main surface 381. The other end of the pin 33 is connected to the handle 36. One end of the pin 34 protrudes from the main surface 381. The other end of the pin 34 is connected to the handle 37.

The pins 33 and 34 and the main surface 381 formed around the pins 33 and 34 form a third joint 73, and have a shape that can be joined to the opening 21 of the optical measuring instrument 2. Specifically, the diameter of the pin 33 is designed to be slightly smaller than twice a radius of curvature of an end of a first portion 211 of the opening 21. The diameter of the pin 34 is designed to be slightly smaller than a width, in the lateral direction, of a second portion 212 of the opening 21. The distance between the central axis of the pin 33 and the central axis of the pin 34 is designed to be equal to the length determined by subtracting the radius of curvature of the end of the first portion 211 from a half of the length, in the longitudinal direction, of the opening 21.

The pins 33 and 34 are examples of “protrusion” of the present disclosure. The main surface 381 is an example of “first flat surface” of the present disclosure.

An imaginary line 395 connecting respective centers of the pins 33 and 34 is parallel to an imaginary line 396 connecting respective centers of the pins 31 and 32. The imaginary line 395 is located halfway between the side surface 391 and a side surface 392 of the plate 39 opposite to the side surface 391.

In the plate 39, two through holes 351 are formed near the side surface 391, along the side surface 391. Further, in the plate 39, two through holes 352 are formed near the side surface 392, along the side surface 392. A relative positional relationship between the two through holes 351 and the two through holes 352 is designed to coincide with a relative positional relationship between the two screw holes 143 and the two screw holes 131 of the installation mount 10. Further, the relative positional relationship of the two through holes 351 with respect to the pins 31 and 32 is designed to be identical to the relative positional relationship of the two screw holes 143 with respect to the hole 141 and the elongated hole 142 in the installation mount 10. The relative positional relationship of the two through holes 352 with respect to the pins 31 and 32 is designed to be identical to the relative positional relationship of the two screw holes 131 with respect to the hole 141 and the elongated hole 142 in the installation mount 10.

The handles 36 and 37 are attached to another main surface 382 (opposite to the main surface 381) of the plate 39 with screws 361 and 371, respectively. By removing the screw 361, a user can move the handle 36 along the direction orthogonal to the main surface 382, to thereby move the pin 33 connected to the handle 36 in the same direction. Similarly, by removing the screw 371, a user can move the handle 37 along the direction orthogonal to the main surface 382, to thereby move the pin 34 connected to the handle 37 in the same direction.

### Flow of Installation Method

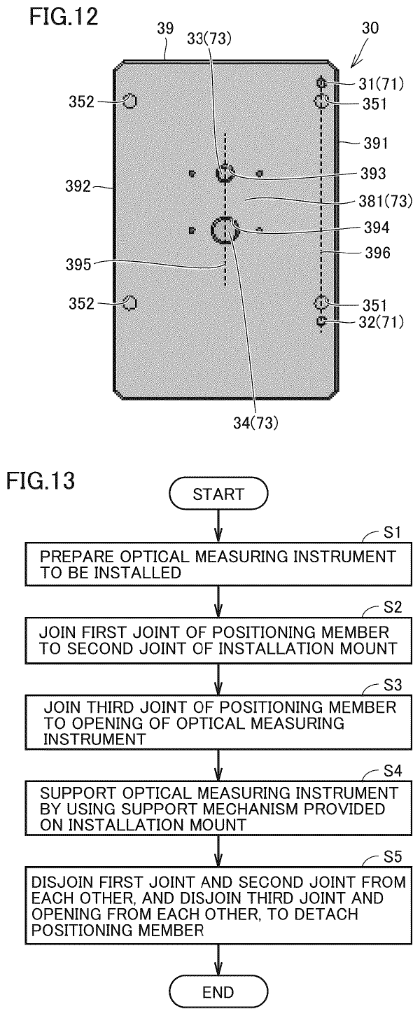

A flow of an installation method for installing the optical measuring instrument 2 is described with reference to FIGS. 13 to 17 in addition to FIGS. 3 to 12. FIG. 13 is a flowchart illustrating an example of the flow of the installation method for installing the optical measuring instrument 2. Steps S1 to S5 included in the installation method are performed by a user.

The installation method includes step S1 of preparing the optical measuring instrument 2 to be installed. In the case where the measuring instrument body 20 and the holder 50 are separated from each other, the user attaches the holder 50 to the measuring instrument body 20 in step S1 (see FIG. 4).

The installation method further includes steps S2 and S3 subsequent to step S1. Step S2 is a step of joining the first joint 71 of the positioning member 30 to the second joint 72 of the installation mount 10. Step S3 is a step of joining the third joint 73 of the positioning member 30 to the opening 21 of the optical measuring instrument 2. Note that step S2 may be performed prior to step S3, or may be performed subsequent to step S3.

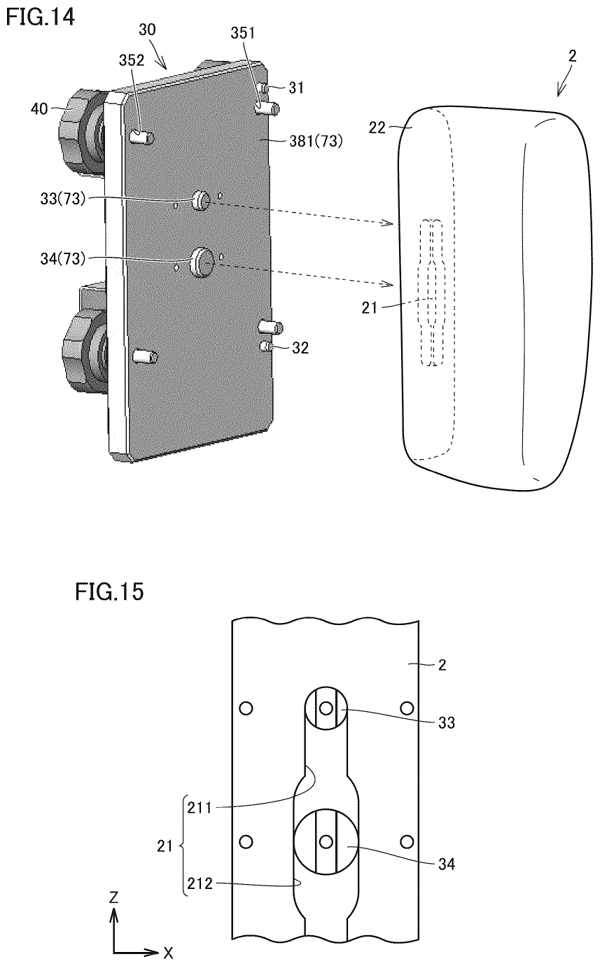

FIG. 14 is a diagram illustrating step S3. As described above, the third joint 73 includes the pins 33 and 34 and the main surface 381 formed around the pins 33 and 34. Therefore, as illustrated in FIG. 14, step S3 includes inserting the pins 33 and 34 of the positioning member 30 into the opening 21 of the optical measuring instrument 2. Further, step S3 includes joining the main surface 381 around the pins 33 and 34 to the flat surface 22 around the opening 21 in the optical measuring instrument 2.

FIG. 15 is a diagram illustrating a positional relationship between the opening of the optical measuring instrument and the pins of the positioning member. As illustrated in FIG. 15, the pin 33 is inserted into the first portion 211 so as to be in contact with the upper end of the first portion 211 of the opening 21. The pin 34 is inserted into a substantially central portion of the second portion 212 of the opening 21. As described above with reference to FIG. 14, the pins 33 and 34 are inserted until the main surface 381 and the flat surface 22 are joined to each other. Thus, the relative position and orientation of the positioning member 30 and those of the optical measuring instrument 2 are determined.

FIG. 16 is a diagram illustrating step S2. Note that FIG. 16 illustrates a state in which step S2 is performed subsequent to step S3. That is, the positioning member 30 to which the optical measuring instrument 2 has already been joined is joined to the installation mount 10.

As described above, the first joint 71 includes the pins 31 and 32. Furthermore, the second joint 72 includes the hole 141 and the elongated hole 142 (see FIG. 6). Therefore, as illustrated in FIG. 16, step S2 includes inserting the pins 31 and 32 of the positioning member 30 into the hole 141 and the elongated hole 142 (see FIG. 6) in the left side plate 14 of the installation mount 10, respectively. As the pin 31 is inserted into the hole 141, the XZ coordinates of the pin 31 are determined in the Cartesian coordinate system with respect to the installation mount 10. Further, as the pin 32 is inserted into the elongated hole 142, rotation of the positioning member 30 about the pin 31 is restricted. The pins 31 and 32 are inserted until the main surface 381 and the left side plate 14 are joined to each other. Thus, the Y coordinate of the positioning member 30 is determined in the Cartesian coordinate system with respect to the installation mount 10. Further, the user causes four screws 40 to pass through the two through holes 351 and the two through holes 352 (see FIGS. 10 and 12) of the positioning member 30 and to be screwed into the two screw holes 143 and the two screw holes 131 (see FIG. 6) of the installation mount 10. Thus, the positioning member 30 is prevented from falling off from the installation mount 10.

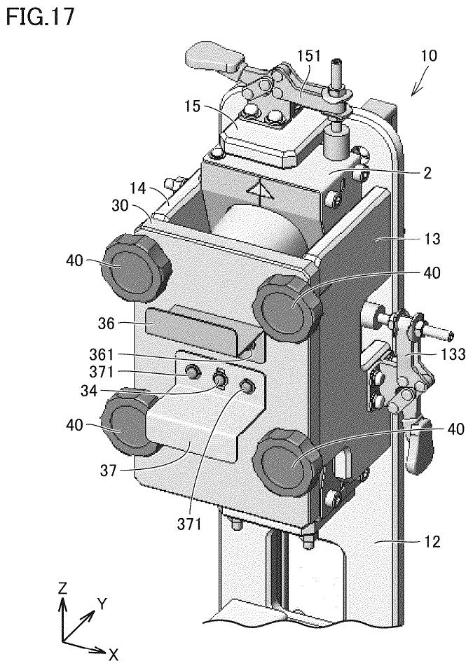

FIG. 17 is an external perspective view of an upper part of the installation mount after completion of steps S2 and S3. Step S2 determines the position and orientation of the positioning member 30 in the Cartesian coordinate system with respect to the installation mount 10. Further, step S3 determines the relative position and orientation of the opening 21 of the optical measuring instrument 2 with respect to the positioning member 30. As a result, the position and orientation of the opening 21 of the optical measuring instrument 2 are also determined in the Cartesian coordinate system with respect to the installation mount 10.

The height of the left side plate 14 with respect to the upright plate 12 is identical to the height of the right side plate 13 with respect to the upright plate 12. Therefore, the main surface 381 (see FIG. 14) of the positioning member 30 joined to the left side plate 14 and the right side plate 13 is parallel to the upright plate 12. As described above, the flat surface 22 of the optical measuring instrument 2 is joined to the main surface 381 of the positioning member 30. In the optical measuring instrument 2, the back surface 56 is parallel to the flat surface 22 (see FIG. 3). Therefore, after steps S2 and S3 are performed, the back surface 56 of the optical measuring instrument 2 is parallel to the upright plate 12 and orthogonal to the Y-axis direction.

As described above, the imaginary line 395 connecting the respective centers of the pins 33 and 34 is parallel to the imaginary line 396 connecting the respective centers of the pins 31 and 32. Further, a line connecting the center of the hole 141 into which the pin 31 is inserted and the center of the elongated hole 142 into which the pin 32 is inserted is parallel to the Z-axis direction. Therefore, the imaginary line 395 connecting the respective centers of the pins 33 and 34 is parallel to the Z-axis direction. The pins 33 and 34 are joined to the opening 21, in the shape of the substantially elongated hole, of the optical measuring instrument 2. Therefore, the longitudinal direction of the opening 21 is parallel to the Z-axis direction. As described above, the side surface 55 of the optical measuring instrument 2 is parallel to the longitudinal direction of the opening 21 and is orthogonal to the flat surface 22. Therefore, after steps S2 and S3 are performed, the side surface 55 of the optical measuring instrument 2 is orthogonal to the X-axis direction.

The upper surface 53 and the lower surface 54 of the optical measuring instrument 2 are orthogonal to the longitudinal direction of the opening 21. That is, after steps S2 and S3 are performed, the upper surface 53 and the lower surface 54 of the optical measuring instrument 2 are orthogonal to the Z-axis direction.

Referring again to FIG. 13, the installation method further includes step S4. Step S4 is a step of supporting the optical measuring instrument 2 by using the support mechanism provided on the installation mount 10, in a state where the first joint is joined to the second joint and the third joint is joined to the opening 21.

Step S1 causes the outer curved surface 23 of the measuring instrument body 20 to be covered by the holder 50 having the flat upper surface 53, lower surface 54, side surface 55, and back surface 56. Therefore, step S4 includes causing the support mechanism to abut on the upper surface 53, the lower surface 54, the side surface 55, and the back surface 56. Thus, the optical measuring instrument 2 is stably supported by the support mechanism. The support mechanism includes, as the first support member, four adjusters 121 whose positions are adjustable along the Y-axis direction. Therefore, step S4 includes adjusting the positions of the four adjusters 121 so as to abut on the optical measuring instrument 2. That is, as illustrated in FIG. 7, the user rotates the bolts 61 of the four adjusters 121 so as to cause the four adjusters 121 to abut on the optical measuring instrument 2 (specifically the back surface 56).

As described above, the back surface 56 is orthogonal to the Y-axis direction. Therefore, the optical measuring instrument 2 receives only a force in the Y-axis direction from the four adjusters 121, and does not receive a force in the X-axis direction or the Z-axis direction. Thus, the measuring instrument body 20 having the outer curved surface 23 is covered by the holder 50 having the flat back surface 56, and thereby, application of a force in an unintended direction to the optical measuring instrument 2 is avoided.

Preferably, adjusting the position of the four adjusters 121 includes adjusting the positions of the four adjusters 121 so that the amount of force in the Y direction received by the main surface 381 of the positioning member 30 from the optical measuring instrument 2 is equal to or less than a first specified value. For example, the user uses a gap gauge to measure a distance of a gap between the main surface 381 and the optical measuring instrument 2, and a distance of a gap between the adjuster 121 and the optical measuring instrument 2. The user moves the position of the adjusters 121 in the Y direction by the sum of these distances. Thus, the amount of force in the Y direction that the main surface 381 receives from the optical measuring instrument 2 is kept equal to or less than the first specified value. Note that the first specified value is determined in advance so that the optical measuring instrument 2 is not displaced by the force received from the four adjuster 121 when the third joint 73 of the positioning member 30 and the opening 21 of the optical measuring instrument 2 are disjoined from each other in step S5 described later herein.

The support mechanism includes, as the second support member, the set of support members 17 of which position is adjustable along the X-axis direction, and which is capable of holding an object in between. Therefore, step S4 includes adjusting the position of the set of support members 17 so as to abut on the optical measuring instrument 2, and holding the optical measuring instrument 2 in between the support members 17.

As described above, the set of support members 17 includes the three or more adjusters 144 and the toggle clamp 133. Therefore, as illustrated in FIG. 6, holding the optical measuring instrument 2 in between the support members 17 includes causing the toggle clamp 133 to press the optical measuring instrument 2. Further, holding the optical measuring instrument 2 in between the support members 17 includes adjusting the positions of the three or more adjusters 144 so as to abut on the optical measuring instrument 2 (specifically the side surface 55), in a state where the toggle clamp 133 presses the optical measuring instrument 2.

As described above, the side surface 55 is orthogonal to the X-axis direction. Therefore, the optical measuring instrument 2 receives only a force in the X-axis direction from the three or more adjusters 144 and does not receive a force in the Y-axis direction or the Z-axis direction. Thus, the measuring instrument body 20 having the outer curved surface 23 is covered by the holder 50 having the flat side surface 55, and thereby, application of a force in an unintended direction to the optical measuring instrument 2 is avoided.

Preferably, holding the optical measuring instrument 2 in between the support members 17 includes adjusting the position of the set of support members 17 so that the amount of force in the X-axis direction received by the pins 33 and 34 from the optical measuring instrument 2 is equal to or less than a second specified value. For example, the user determines, based on a friction force generated when removing the screws 371 and pulling out the handle 37, whether the amount of force in the X-axis direction that the pin 34 attached to the handle 37 receives from the optical measuring instrument 2 is equal to or less than the second specified value. Alternatively, the user may use a force gauge to measure the amount of force exerted when pulling out the pin 34. Alternatively, the user may attach a strain gauge to the pin 34 and measure the amount of force in the X-axis direction received by the pin 34 from the optical measuring instrument 2, based on strain of the pin 34. Note that the second specified value is determined in advance so that the optical measuring instrument 2 is not displaced by a force received from the set of support members 17 when the third joint of the positioning member 30 and the opening 21 of the optical measuring instrument 2 are disjoined from each other in step S5 described later herein.

The support mechanism includes, as the third support member, the set of support members 18 of which position is adjustable along the Z-axis direction, and which is capable of holding an object in between. Therefore, step S4 includes adjusting the position of the set of support members 18 so as to abut on the optical measuring instrument 2, and holding the optical measuring instrument 2 in between the support members 18.

As described above, the set of support members 18 includes the three or more adjusters 161 and the toggle clamp 151. Therefore, as illustrated in FIG. 6, holding the optical measuring instrument 2 in between the support members 18 includes causing the toggle clamp 151 to press the optical measuring instrument 2. Further, holding the optical measuring instrument 2 in between the support members 18 includes adjusting the positions of the three or more adjusters 161 so as to abut on the optical measuring instrument 2 (specifically the lower surface 54), in a state where the toggle clamp 151 presses the optical measuring instrument 2.

As described above, the lower surface 54 is orthogonal to the Z-axis direction. Therefore, the optical measuring instrument 2 receives only a force in the Z-axis direction from the three or more adjusters 161 and does not receive a force in the X-axis direction or the Y-axis direction. Thus, the measuring instrument body 20 having the outer curved surface 23 is covered by the holder 50 having the flat lower surface 54, and thereby, application of a force in an unintended direction to the optical measuring instrument 2 is avoided.

Preferably, holding the optical measuring instrument 2 in between the support members 18 includes adjusting the position of the set of support members 18 so that the amount of force in the Z-axis direction received by the pin 33 from the optical measuring instrument 2 is equal to or less than a third specified value. For example, the user determines, based on a friction force generated when removing the screw 361 and pulling out the handle 36, whether the amount of force in the Z-axis direction that the pin 33 attached to the handle 36 receives from the optical measuring instrument 2 is equal to or less than the third specified value. Alternatively, the user may use a force gauge to measure the amount of force exerted when pulling out the pin 33. Alternatively, the user may attach a strain gauge to the pin 33 and measure the amount of force in the Z-axis direction received by the pin 33 from the optical measuring instrument 2, based on strain of the pin 33. Note that the third specified value is determined in advance so that the optical measuring instrument 2 is not displaced by a force received from the set of support members 18 when the third joint of the positioning member 30 and the opening 21 of the optical measuring instrument 2 are disjoined from each other in step S5 described below.

Referring again to FIG. 13, the installation method further includes step S5. Step S5 is a step of disjoining the first joint 71 and the second joint 72 from each other and disjoining the third joint 73 and the opening 21 from each other, in a state where the optical measuring instrument 2 is supported by the support mechanism. Thus, the positioning member 30 is separated from the installation mount 10 and the optical measuring instrument 2.

The installation method further includes step S6. Step S6 is a step of installing the installation mount 10 at a specific position on the bedplate 6. Note that step S6 may be performed immediately after any of steps S1 to S4.

The bedplate 6 includes, for example, a plurality of parallel pins that can be inserted into a plurality of holes provided in the base plate 11, as a structure for positioning the base plate 11 of the installation mount 10. Therefore, the user may use this structure to install the installation mount 10 on the bedplate 6. Thus, a coordinate transformation matrix between the Cartesian coordinate system with respect to the installation mount 10 and the Cartesian coordinate system with respect to the system origin 7 is determined. The computer 8 can specify the position and orientation of the installation mount 10 in the Cartesian coordinate system with respect to the system origin 7, by using the coordinate transformation matrix. The relative positional relationship between the installation mount 10 and the opening 21 of the optical measuring instrument 2 is specified in advance, based on respective positions of the first joint 71, the second joint 72, the third joint 73, and the opening 21. Therefore, the computer 8 can specify the position and orientation of the opening 21 based on the relative positional relationship between the installation mount 10 and the opening 21 of the optical measuring instrument 2.

### Modification

According to the foregoing, each of the sets of support members 17 and 18 includes a combination of three or more adjusters and a toggle clamp. However, one of the sets of support members 17 and 18 may include three or more adjusters instead of the toggle clamp.

### Supplementary Notes

The above-described embodiment includes the following technical ideas.

### [Configuration 1]

An installation method for installing an optical measuring instrument on an installation mount by using a positioning member (or positioning plate), the installation method comprising:
joining a first joint provided on the positioning member to a second joint provided on the installation mount; and
joining a third joint provided on the positioning member to an opening provided in the optical measuring instrument, the opening defining an optical path of the optical measuring instrument.

### [Configuration 2]

The installation method according to Configuration 1, wherein the joining the first joint to the second joint is performed prior to the joining the third joint to the opening.

### [Configuration 3]

The installation method according to Configuration 1, wherein the joining the first joint to the second joint is performed subsequent to the joining the third joint to the opening.

### [Configuration 4]

The installation method according to Configuration 1, wherein
the third joint includes: a protrusion insertable into the opening; and a first flat surface formed around the protrusion, and
the joining the third joint to the opening includes:
   inserting the protrusion into the opening; and
   joining the first flat surface to a second flat surface around the opening in the optical measuring instrument.

### [Configuration 5]

The installation method according to Configuration 1, further comprising supporting the optical measuring instrument by using a support mechanism provided on the installation mount, in a state where the first joint is joined to the second joint and the third joint is joined to the opening.

### [Configuration 6]

The installation method according to Configuration 5, wherein
the optical measuring instrument has a flat surface in which the opening is formed,
the support mechanism includes:
   a first support member (or support tool) whose position is adjustable along a first direction orthogonal to the flat surface;
   a second support member (or support tool) whose position is adjustable along a second direction orthogonal to the first direction, the second support member being capable of holding an object; and
   a third support member whose (or support tool) position is adjustable along a third direction orthogonal to the first direction and the second direction, the third support member being capable of holding the object, and
supporting the optical measuring instrument includes:
   adjusting the position of the first support member to cause the first support member to abut on the optical measuring instrument;
   adjusting the position of the second support member to cause the second support member to abut on the optical measuring instrument, and hold the optical measuring instrument by the second support member; and
   adjusting the position of the third support member to cause the third support member to abut on the optical measuring instrument, and hold the optical measuring instrument by the third support member.

### [Configuration 7]

The installation method according to Configuration 6, wherein
at least one of the second support member and the third support member includes:
   an adjuster whose position relative to the optical measuring instrument is adjustable, and
   a presser that is located opposite to the adjuster with the optical measuring instrument interposed between the presser and the adjuster, and presses the optical measuring instrument toward the adjuster, and
adjusting the position of the at least one of the second support member and the third support member to hold the optical measuring instrument between the at least one of the second support member or the third support member includes:
   causing the presser to press the optical measuring instrument; and
   adjusting the position of the adjuster to cause the adjuster to abut on the optical measuring instrument, in a state where the presser presses the optical measuring instrument.

### [Configuration 8]

The installation method according to Configuration 6, wherein
adjusting the position of the first support member includes adjusting the position of the first support member so that an amount of force in the first direction received by the third joint from the optical measuring instrument is equal to or less than a first specified value,
the holding the optical measuring instrument by the second support member includes adjusting the position of the second support member so that an amount of force in the second direction received by the third joint from the optical measuring instrument is equal to or less than a second specified value, and
the holding the optical measuring instrument by the third support member includes adjusting the position of the third support member so that an amount of force in the third direction received by the third joint from the optical measuring instrument is equal to or less than a third specified value.

### [Configuration 9]

The installation method according to any one of Configuration 5, wherein
the optical measuring instrument includes:
   a body including the opening and having an outer curved surface; and
   a holder attached to the body to cover the outer curved surface,
the holder has an outer flat surface, and
the supporting the optical measuring instrument includes causing the support mechanism to abut on the outer flat surface.

### [Configuration 10]

The installation method according to any one of Configuration 5, further comprising disjoining the first joint and the second joint from each other and disjoining the third joint and the opening from each other, in a state where the optical measuring instrument is supported by the support mechanism.

### [Configuration 11]

A jig set comprising:
an installation mount; and
a positioning member (or positioning plate) that assists installation of an optical measuring instrument on the installation mount, wherein
the positioning member includes a first joint that has a shape capable of being joined to a second joint provided on the installation mount,
the positioning member further includes a third joint that has a shape capable of being joined to an opening provided in the optical measuring instrument, the opening defining an optical path of the optical measuring instrument, and
the installation mount includes a support mechanism that supports the optical measuring instrument to maintain a relative positional relationship between the installation mount and the optical measuring instrument, in a state where the first joint is joined to the second joint and the third joint is joined to the opening.

Although embodiments of the present invention have been described and illustrated in detail, the disclosed embodiments are made for purposes of illustration and example only and not limitation. The scope of the present invention should be interpreted by terms of the appended claims.

1. An installation method for installing an optical measuring instrument on an installation mount by using a positioning plate, the installation method comprising:
joining a first joint provided on the positioning plate to a second joint provided on the installation mount; and
joining a third joint provided on the positioning plate to an opening provided in the optical measuring instrument, the opening defining an optical path of the optical measuring instrument.

2. The installation method according to claim 1, wherein the joining the first joint to the second joint is performed prior to the joining the third joint to the opening.

3. The installation method according to claim 1, wherein the joining the first joint to the second joint is performed subsequent to the joining the third joint to the opening.

4. The installation method according to claim 1, wherein
the third joint includes:
a protrusion insertable into the opening; and
a first flat surface formed around the protrusion, and
the joining the third joint to the opening includes:
inserting the protrusion into the opening; and
joining the first flat surface to a second flat surface around the opening in the optical measuring instrument.

5. The installation method according to claim 1, further comprising
supporting the optical measuring instrument by using a support mechanism provided on the installation mount, in a state where the first joint is joined to the second joint and the third joint is joined to the opening.

6. The installation method according to claim 5, wherein
the optical measuring instrument has a flat surface in which the opening is formed,
the support mechanism includes:
a first support tool whose position is adjustable along a first direction orthogonal to the flat surface;
a second support tool whose position is adjustable along a second direction orthogonal to the first direction, the second support tool being capable of holding an object; and
a third support tool whose position is adjustable along a third direction orthogonal to the first direction and the second direction, the third support tool being capable of holding the object, and
supporting the optical measuring instrument includes:
adjusting the position of the first support tool to cause the first support tool to abut on the optical measuring instrument;
adjusting the position of the second support tool members to cause the second support tool to abut on the optical measuring instrument, and hold the optical measuring instrument by the second support tool; and
adjusting the position of the third support tool to cause the third support tool to abut on the optical measuring instrument, and hold the optical measuring instrument by the third support tool.

7. The installation method according to claim 6, wherein
at least one of the second support tool and the third support tool includes:
an adjuster whose position relative to the optical measuring instrument is adjustable, and
a presser that is located opposite to the adjuster with the optical measuring instrument interposed between the presser and the adjuster, and presses the optical measuring instrument toward the adjuster, and
adjusting the position of the at least one of the second support tool and the third support tool to hold the optical measuring instrument between the at least one of the second support tool and the third support tool includes:
causing the presser to press the optical measuring instrument; and
adjusting the position of the adjuster to cause the adjuster to abut on the optical measuring instrument, in a state where the presser presses the optical measuring instrument.

8. The installation method according to claim 6, wherein
the adjusting the position of the first support tool includes adjusting the position of the first support tool so that an amount of force in the first direction received by the third joint from the optical measuring instrument is equal to or less than a first specified value,
the holding the optical measuring instrument by the second support tool includes adjusting the position of the second support tool so that an amount of force in the second direction received by the third joint from the optical measuring instrument is equal to or less than a second specified value, and
the holding the optical measuring instrument by the third support tool includes adjusting the position of the third support tool so that an amount of force in the third direction received by the third joint from the optical measuring instrument is equal to or less than a third specified value.

9. The installation method according to claim 5, wherein
the optical measuring instrument includes:
a body including the opening and having an outer curved surface; and
a holder attached to the body to cover the outer curved surface,
the holder has an outer flat surface, and
the supporting the optical measuring instrument includes causing the support mechanism to abut on the outer flat surface.

10. The installation method according to claim 5, further comprising:
disjoining the first joint and the second joint from each other and disjoining the third joint and the opening from each other, in a state where the optical measuring instrument is supported by the support mechanism.

11. A jig set comprising:
an installation mount; and
a positioning plate that assists installation of an optical measuring instrument on the installation mount, wherein
the positioning plate includes a first joint that has a shape capable of being joined to a second joint provided on the installation mount,
the positioning plate further includes a third joint that has a shape capable of being joined to an opening provided in the optical measuring instrument, the opening defining an optical path of the optical measuring instrument, and
the installation mount includes a support mechanism that supports the optical measuring instrument to maintain a relative positional relationship between the installation mount and the optical measuring instrument, in a state where the first joint is joined to the second joint and the third joint is joined to the opening.
